(19) United States
(12) Patent Application Publication
(10) Pub. No.: US 2008/0168518 A1
(43) Pub. Date: Jul. 10, 2008

(54) Method of reducing upstream ingress noise in cable data system

(75) Inventors: Jin-Jen Hsue, Hsinchu County (TW); Wei-Chih Lu, Taipei County (TW)

Correspondence Address: BIRCH STEWART KOLASCH & BIRCH, PO BOX 747, FALLS CHURCH, VA, 22040-0747, US

(73) Assignee: HITRON TECHNOLOGIES INC.

(21) Appl. No.: 11/649,858

(22) Filed: Jan. 5, 2007

(51) Int. Cl. H04N 7/173

(52) U.S. Cl. 725/125

(57) ABSTRACT

In a method of reducing upstream ingress noise in cable data system, downstream management messages containing information about user group data uploading time and channel frequency are broadcasted by a headend of the cable data system. The broadcasted downstream management messages are monitored, so as to determine an upstream channel connection time schedule for the user groups. Each user group is connected to an upstream channel of the headend only at a data uploading time scheduled for that user group. As a result, ingress noise existed in the user group will be uploaded to the headend only when the user group is connected to the headend. Therefore, accumulation of upstream ingress noise at the headend is effectively reduced, and the headend network can maintain good signal quality to ensure best network connection.

### FIELD OF THE INVENTION

The present invention relates to a method of reducing upstream ingress noise in cable data system, and more particularly to a method of reducing upstream ingress noise in cable data system, in which a plurality of upstream ingress noise blocking systems are mounted between a headend of the system and a plurality of user groups to monitor user group data uploading time and channel frequency contained in downstream broadcasting messages from the headend and determine an upstream channel connection time schedule for the user groups.

### BACKGROUND OF THE INVENTION

The use of networks has become indispensable in most people's daily life. Various high-tech network transmission systems have been developed in response to people's increasing demands for network transmission and many other applications thereof. One example of these network transmission systems is a cable data system, which has the advantages of having large bandwidth and quick transmission speed. In a standard cable for bidirectional transmission, a bandwidth between 5 MHz and 42 MHz (in the case of American standard) or between 5 MHz and 65 MHz (in the case of European standard) is used as are turn path for an upstream signal. However, the above-mentioned bandwidths fall in a zone within which signal interference frequently occurs due to all kinds of radio-frequency (RF) broadcast signals and electric wave noise sources. Meanwhile, loosened or poor-contacted indoor electrical appliance cords would also cause signal interference. As shown in FIG. 1, a cable television (CATV) network is a tree network, and all upstream noises would be returned via the network to gather and accumulated at a headend of the CATV network.

There are methods developed for reducing upstream ingress noise in a cable data system, such as dynamic noise blocking technique, upstream power pre-emphasizing technique, etc.

In the dynamic noise blocking technique, an upstream signal from a client is detected. When the upstream signal is detected as having signal energy exceeded a threshold value, the upstream signal is determined as a client upstream signal. Otherwise, the upstream signal is determined as a noise. When an upstream signal is determined, the network is linked to allow transmission of the signal to the headend of the network. Otherwise, the network is down. In brief, the dynamic noise blocking technique utilizes digital signal processing (DSP) technique to check and determine whether a received upstream signal has energy exceeded a threshold value. It is known that the analysis of an upstream signal power requires a large amount of operation and real-time conversion, which is done with special hardware or chips, and therefore requires high cost.

In the upstream power pre-emphasizing technique, the client transmits an upstream signal with higher power, which would sometimes exceed a standard level. The high power of the upstream signal is then attenuated by specific means in a cable allocation system to a receiving range acceptable by the headend of the network. Since a signal with higher power has a high signal-to-noise ratio (SNR), the noise accompanying the signal is attenuated at the same time by the specific means in the cable allocation system. As a result, the upstream ingress noise is reduced at the headend. In the upstream power pre-emphasizing technique, it is necessary to supply an over-standard upstream power. For this purpose, cable modems located at the clients require modification in hardware. Moreover, this technique does not comply with DOCSIS (Data over Cable System Interface Specifications).

Therefore, it is desirable to develop a method of reducing upstream ingress noise in cable data system, which may be implemented at low cost using easily producible hardware, and is in compliance with DOCSIS.

### SUMMARY OF THE INVENTION

A primary object of the present invention is to provide a method of reducing upstream ingress noise in cable data system, so as to solve the problem of deteriorated network transmission quality caused by ingress noise that is existed in user groups and returned via upstream network to gather and accumulate at a headend of the system.

To achieve the above object, the method of reducing upstream ingress noise in cable data system according to the present invention includes the following steps: (1) providing a plurality of upstream ingress noise blocking systems, each of which is mounted between a headend of the cable data system and one of a plurality of user groups; (2) causing the upstream ingress noise blocking systems and the user groups to synchronously use an upstream channel of the headend; (3) causing the upstream ingress noise blocking systems to simultaneously monitor downstream broadcast signals independently transmitted from the headend to each of the user groups, wherein each of the downstream broadcast signals includes information about data uploading time for a corresponding one of the user groups; and an upstream channel connection time schedule being determined for the upstream ingress noise blocking systems and the user groups based on the data uploading time for each of the user groups; and (4) causing the upstream ingress noise blocking systems to separately connect the corresponding user groups to the upstream channel according to the upstream channel connection time schedule, so that data from each of the user groups may be uploaded to the headend.

With the above steps, the ingress noise existed in user groups of a cable data system and returned via an upstream network would not gather and accumulate at the headend of the system to result in deteriorated network transmission quality.

### BRIEF DESCRIPTION OF-THE DRAWINGS

The structure and the technical means adopted by the present invention to achieve the above and other objects can be best understood by referring to the following detailed description of the preferred embodiments and the accompanying drawings, wherein

FIG. 1 shows a conventional cable data system, in which noises are returned from clients via a network to gather and accumulate at a headend of the system;

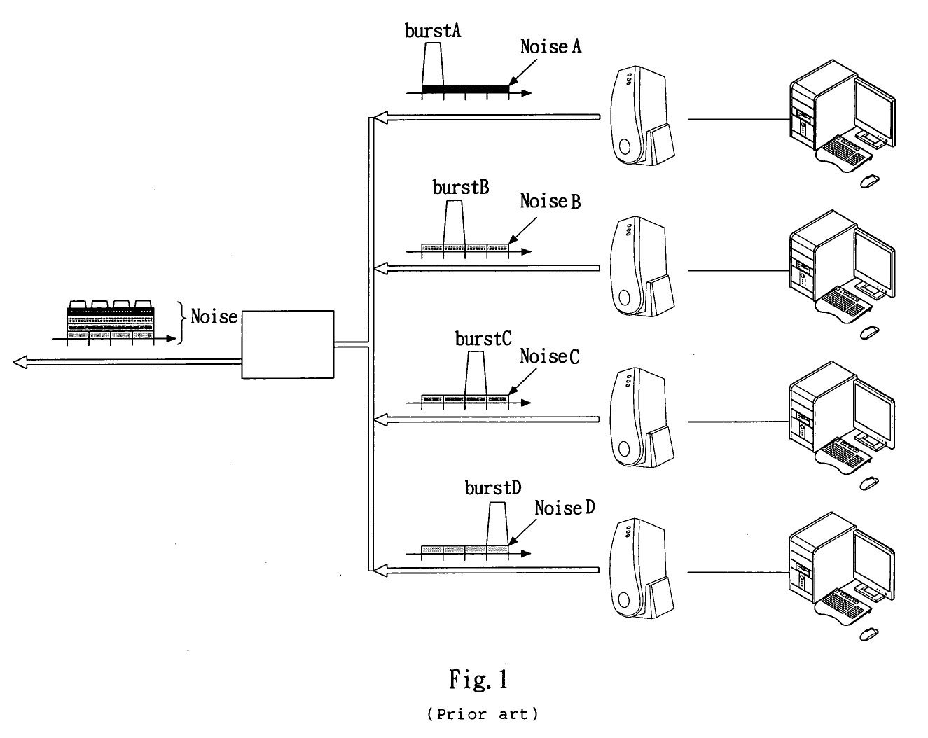

FIG. 2 is a flowchart showing the steps included in the method of reducing upstream ingress noise in cable data system according to the present invention; and

FIG. 3 shows a preferred example of reducing upstream ingress noise in cable data system using the method of the present invention.

### DETAILED DESCRIPTION OF THE PREFERRED EMBODIMENTS

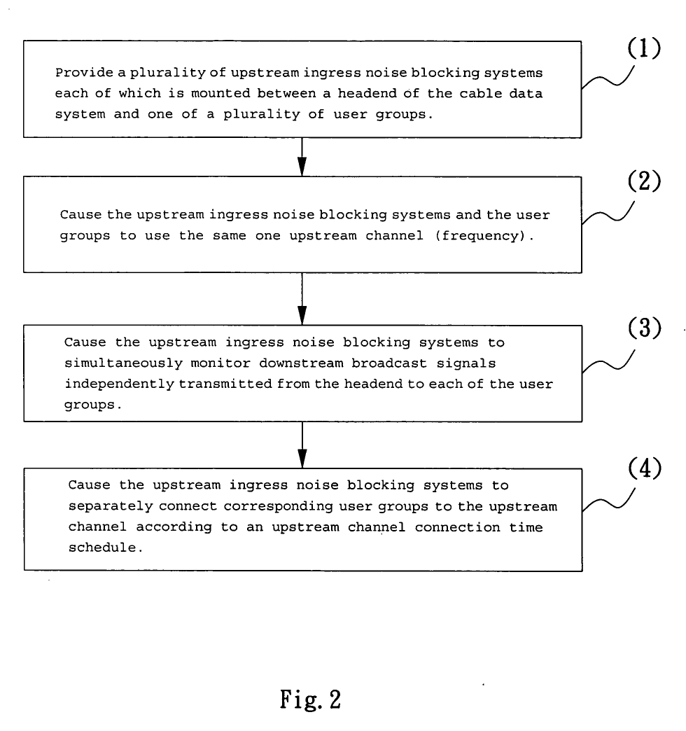

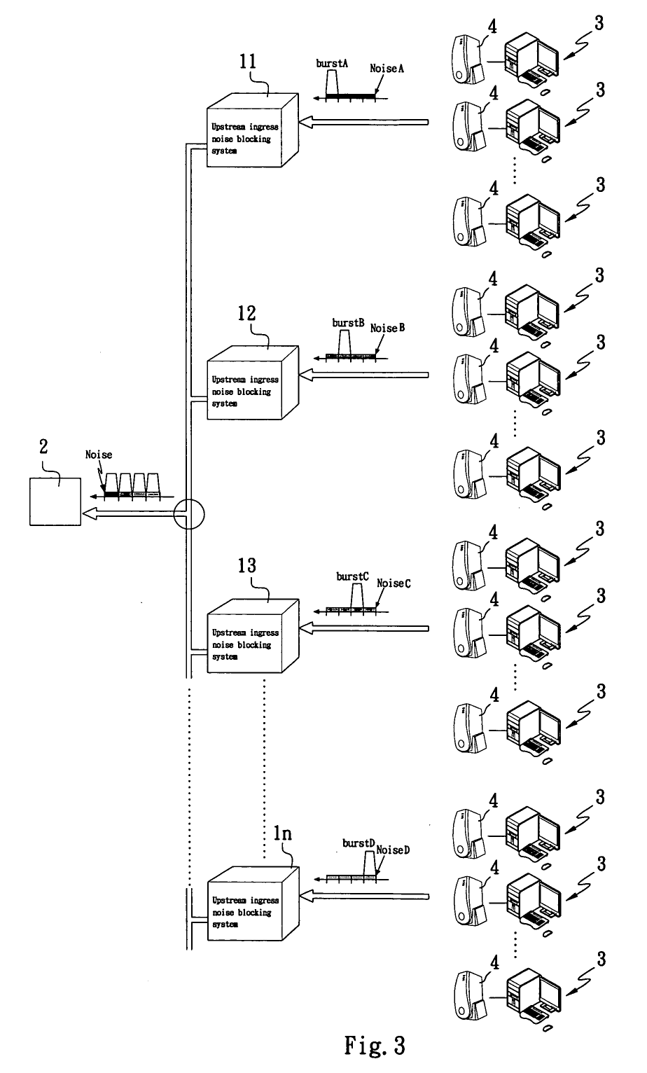

Please refer to FIG. 2 that is a flowchart showing the steps included in a method of reducing upstream ingress noise in cable data system according to the present invention, and to FIG. 3 that shows a preferred example of reducing upstream ingress noise in cable data system using the method of the present invention.

In a first step (1), a plurality of upstream ingress noise blocking systems 11-1n are provided for mounting between a headend 2, which may be, for example, a cable modem termination system (CMTS), and a plurality of user groups A-D. Each of the user groups A-D includes a plurality of users, which may include a plurality of electronic apparatus 3 with web connection function. The electronic apparatus 3 may include but not limited to personal computers, notebook computers, and personal digital assistants (PDA). Each user is connected via a cable modem 4 to a corresponding one of the upstream ingress noise blocking systems 11-1n.

In a second step (2), all the upstream ingress noise blocking systems 11-1n and the user groups A-D are caused to use the same one upstream channel (frequency).

In a third step (3), the upstream ingress noise blocking systems 11-1n are caused to simultaneously monitor downstream broadcast signals independently transmitted by the headend 2 to one of the user groups A-D. The downstream broadcast signals include messages about the time for each user group A-D to upload data, so that an upstream channel connection time schedule is determined for the upstream ingress noise blocking systems 11-1n and the user groups A-D. The downstream broadcast signals may be a data message or a management message, which may be a management message described in DOCSIS. The management message may be further divided into three types, namely, (I) upstream bandwidth allocation—MAP message, which is the most important message describing time points, opportunities, channels available for data uploading, and corresponding service numbers. From the upstream bandwidth allocation—MAP message, the upstream ingress noise blocking systems 11-1n are able to know when the data from the user groups A-D may be uploaded; (II) time synchronization—SYNC message, which is a synchronized control signal for the upstream ingress noise blocking systems 11-1n and all the user groups A-D, and describes the current time at the headend 2; and (III) upstream channel descriptor—UCD message, which includes information about the upstream channel of the cable data system, including channel number, frequency, time unit, way of numbering, burst description, etc. Based on the upstream bandwidth allocation—MAP message, the upstream ingress noise blocking systems 11-1n set the data uploading time for each user group A-D in the upstream channel connection time schedule.

In a fourth step (4), the upstream ingress noise blocking systems 11-1n are connected to the upstream channel based on the upstream channel connection time schedule, so that data from the user groups A-D may be separately uploaded to the headend 2 at uploading time of burst A, burst B, burst C, and burst D. For example, the upstream ingress noise blocking system 11 connects the upstream channel to the user group A at the data uploading time of burst A. At this point, a burst A signal will pass through the upstream ingress noise blocking system 11 to reach at the headend 2. Then, the upstream ingress noise blocking system 12 connects the upstream channel to the user group B at the data uploading time of burst B. At this point, a burst B signal will pass through the upstream ingress noise blocking system 12 to reach at the headend 2. And, the user groups C, D are separately connected to the upstream channel via the upstream ingress noise blocking systems 13, 1n in the same manner.

In this manner, upstream ingress noise being returned from the user groups A-D exists only when the user groups are connected to the upstream channel via corresponding upstream ingress noise blocking systems 11-1n at the corresponding data uploading time of burst A-D. With these arrangements, the upstream ingress noise returned via the upstream channel would not gather and accumulate at the headend 2 to adversely affect the quality of network communication.

From the above described steps (1) to (4) in the method of the present invention, it can be clearly seen that the problem of gathered and accumulated upstream ingress noise in a cable data system has been effectively improved. In brief, the method of the present invention complies with DOCSIS and advantageously reduces the upstream ingress noise in a cable data system, and may be implemented using general cable modems or similar hardware. Therefore, the present invention is novel and improved, and industrially valuable for use.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A method of reducing upstream ingress noise in cable data system, comprising the steps of:
(1) providing a plurality of upstream ingress noise blocking systems, each of which is mounted between a headend of the cable data system and one of a plurality of user groups;
(2) causing the upstream ingress noise blocking systems and the user groups to synchronously use an upstream channel of the headend;
(3) causing the upstream ingress noise blocking systems to simultaneously monitor downstream broadcast signals independently transmitted from the headend to each of the user groups, wherein each of the downstream broadcast signals includes information about data uploading time for a corresponding one of the user groups; and an upstream channel connection time schedule being determined for the upstream ingress noise blocking systems and the user groups based on the data uploading time for each of the user groups; and
(4) causing the upstream ingress noise blocking systems to separately connect the corresponding user groups to the upstream channel according to the upstream channel connection time schedule, so that data from each of the user groups may be uploaded to the headend.

2. The method of reducing upstream ingress noise in cable data system as claimed in claim 1, wherein the headend is a cable modem termination system (CMTS).

3. The method of reducing upstream ingress noise in cable data system as claimed in claim 1, wherein each of the user groups includes a plurality of users, and each of the users is connected to a corresponding one of the upstream ingress noise blocking systems via a cable modem.

4. The method of reducing upstream ingress noise in cable data system as claimed in claim 3, wherein the users are electronic apparatus with web connection function.

5. The method of reducing upstream ingress noise in cable data system as claimed in claim 4, wherein the electronic apparatus are selected from the group consisting of personal computers, notebook computers, and digital personal assistants (PDA's).

6. The method of reducing upstream ingress noise in cable data system as claimed in claim 1, wherein each of the downstream broadcast signals is a management message as described in DOCSIS (Data over Cable System Interface Specifications).

7. The method of reducing upstream ingress noise in cable data system as claimed in claim 6, wherein the management message includes an upstream bandwidth allocation—MAP message, a time synchronization—SYNC message, and an upstream channel descriptor—UCD message.
